(19) United States
(12) Patent Application Publication
(10) Pub. No.: US 2018/0046029 A1
(43) Pub. Date: Feb. 15, 2018

(54) Backlight Module And Liquid Crystal Display Device

(71) Applicant: Wuhan China Star Optoelectronics Technology Co., Ltd., Wuhan, Hubei (CN)

(72) Inventors: Qing GUO, Shenzhen, Guangdong (CN); Chen XIE, Shenzhen, Guangdong (CN)

(73) Assignee: Wuhan China Star Optoelectronics Technology Co., Ltd., Wuhan, Hubei (CN)

(21) Appl. No.: 15/101,950

(22) PCT Filed: May 17, 2016
(86) PCT No.: PCT/CN2016/082306

§ 371 Date: Jun. 6, 2016

(30) Foreign Application Priority Data
Feb. 16, 2016 (CN) 201610087122.8

(51) Int. Cl. G02F 1/1335; F21V 8/00

(52) U.S. Cl. CPC G02F 1/133608; G02B 6/0086; G02B 6/0085; G02F 2001/133628

(57) ABSTRACT

A backlight module and a liquid crystal display device. The backlight module includes a back frame including a plastic frame and a reinforcement member. The stiffness of the reinforcement member is greater than the stiffness of the plastic frame. The plastic frame includes four side walls connected in an end-to-end arrangement, sequentially as a first, a second, a third and a fourth side wall. The first side wall is adjacent to a light source. The reinforcement member is disposed at outside of an inner side surface and an outside of a bottom surface connected with the inner side surface. Accordingly, through the reinforcement member, a heat generated by the light source is conducted to an exterior of the backlight module, and the bottom surface is a surface away from the display panel. The back frame of the present invention has a good heat dissipation performance and anti-disturbance stiffness.

### BACKGROUND OF THE INVENTION

### 1. Field of the Invention

The present invention relates to a display field, and more particularly to a backlight module and a liquid crystal display device.

### 2. Description of Related Art

A liquid crystal display device has features of low radiation, thin thickness, low power consumption and so on such that the device is widely applied in desktop computers, laptops, personal digital assistants, cell phones, television, etc. Because the liquid crystal display panel cannot emit light, in order to achieve a display effect, a surface light source is required for the liquid crystal display panel for achieving the display function. For example, a backlight module, used for providing a surface light source which is evenly distributed and having a sufficient brightness.

The backlight module usually includes a back frame, a light source, a light guide plate and multiple optical films, the light source, the light guide plate and multiple optical films are all fixed to the back frame. In other words, the light source, the light guide plate and multiple optical films are fixed relatively through the back frame.

In the conventional art, the back frame is made of a plastic material. However, the anti-disturbance stiffness of the plastic material is smaller, and easily to generate bending and deformation when assembling so as to affect the assembly precision. Besides, the heat conduction performance of the plastic material is poor so that the back frame adopting the plastic material cannot effectively dissipate heat for the light source.

### SUMMARY OF THE INVENTION

The technology problem mainly solved by the present invention is to provide a back frame of a backlight module and a liquid crystal display device having larger anti-disturbance stiffness and better heat conduction performance.

In order to solve the above technology problem, a technology solution adopted by the present invention is: a backlight module for providing a backlight source to a display panel, comprising: a back frame including a plastic frame and a reinforcement member; wherein, a stiffness of the reinforcement member is greater than a stiffness of the plastic frame; the plastic frame includes four side walls connected in an end-to-end arrangement, sequentially as a first side wall, a second side wall, a third side wall and a fourth side wall; the first side wall is adjacent to a light source of a backlight module; the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the bottom surface is a surface that is away from the display panel.

Wherein, the reinforcement member is further disposed at the third side wall.

Wherein, the reinforcement member includes two “-” shaped sub-reinforcement members respectively extended along the first side wall and the third side wall.

Wherein, the reinforcement member is further disposed at the second side wall and the fourth side wall.

Wherein, the reinforcement member includes three “-” shaped sub-reinforcement members; or one “L” shaped and one “-” shaped sub-reinforcement members; or the reinforcement member is “[” shaped.

Wherein, the reinforcement member is further disposed at the second side wall and the fourth side wall, and the reinforcement member includes four “-” shaped sub-reinforcement members; or the reinforcement includes two “L” shaped sub-reinforcement members; or the reinforcement member includes one “[” shaped sub-reinforcement member and one “-” shaped sub-reinforcement member; or the reinforcement member is “□” shaped matching with the plastic frame.

Wherein, the reinforcement member is further disposed at an outer side surface of the first side wall, wherein, the outer side surface is opposite to the inner side surface.

Wherein, the reinforcement member and the plastic frame are formed integrally.

Wherein, the reinforcement member is a metal material.

In order to solve above technology problem, a technology solution adopted by the present invention is: a liquid crystal display device, wherein, the liquid crystal display device includes a backlight module and a display panel which are overlapped, and the backlight module comprises: a back frame including a plastic frame and a reinforcement member; wherein, a stiffness of the reinforcement member is greater than a stiffness of the plastic frame; the plastic frame includes four side walls connected in an end-to-end arrangement, sequentially as a first side wall, a second side wall, a third side wall and a fourth side wall; the first side wall is adjacent to a light source of a backlight module; the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the bottom surface is a surface that is away from the display panel.

Wherein, the reinforcement member is further disposed at the third side wall.

Wherein, the reinforcement member includes two “-” shaped sub-reinforcement members respectively extended along the first side wall and the third side wall.

Wherein, the reinforcement member is further disposed at the second side wall and the fourth side wall.

Wherein, the reinforcement member includes three “-” shaped sub-reinforcement members; or one “L” shaped and one “-” shaped sub-reinforcement members; or the reinforcement member is “[” shaped.

Wherein, the reinforcement member is further disposed at the second side wall and the fourth side wall, and the reinforcement member includes four “-” shaped sub-reinforcement members; or the reinforcement includes two “L” shaped sub-reinforcement members; or the reinforcement member includes one “[” shaped sub-reinforcement member and one “-” shaped sub-reinforcement member; or the reinforcement member is “□” shaped matching with the plastic frame.

Wherein, the reinforcement member is further disposed at an outer side surface of the first side wall, wherein, the outer side surface is opposite to the inner side surface.

Wherein, the reinforcement member and the plastic frame are formed integrally.

Wherein, the reinforcement member is a metal material.

The beneficial effect of the present invention is: comparing to the conventional art, the back frame of the backlight module of the present invention includes a plastic frame and a reinforcement member. the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the backlight module has a better heat dissipation effect. At the same time, because the stiffness of the reinforcement member is greater than the stiffness of the plastic frame, the anti-disturbance stiffness of the back frame is increased so as to avoid generating bending and deformation when assembling, and the assembly precision is higher.

### BRIEF DESCRIPTION OF THE DRAWINGS

FIG. 1 is schematic diagram of a liquid crystal display device of the present invention;

FIG. 2 is a schematic diagram of a back frame of a backlight module of the liquid crystal display device shown in FIG. 1 of a first embodiment;

FIG. 3 is a cross-sectional view of the back frame along an A-A direction;

FIG. 4 is a schematic diagram of a back frame of a backlight module of the liquid crystal display device shown in FIG. 1 of a second embodiment;

FIG. 5 is a cross-sectional view of the back frame along a B-B direction;

FIG. 6 is a schematic diagram of a back frame of a backlight module of the liquid crystal display device shown in FIG. 1 of a third embodiment;

FIG. 7 is a schematic diagram of a back frame of a backlight module of the liquid crystal display device shown in FIG. 1 of a fourth embodiment;

FIG. 8 is a schematic diagram of a back frame of a backlight module of the liquid crystal display device shown in FIG. 1 of a fifth embodiment;

FIG. 9 is a schematic diagram of a back frame of a backlight module of the liquid crystal display device shown in FIG. 1 of a sixth embodiment;

FIG. 10 is a schematic diagram of a back frame of a backlight module of the liquid crystal display device shown in FIG. 1 of a seventh embodiment;

FIG. 11 a schematic diagram of a back frame of a backlight module of the liquid crystal display device shown in FIG. 1 of an eighth embodiment;

FIG. 12 a schematic diagram of a back frame of a backlight module of the liquid crystal display device shown in FIG. 1 of a ninth embodiment; and

FIG. 13 a schematic diagram of a back frame of a backlight module of the liquid crystal display device shown in FIG. 1 of a tenth embodiment.

### DETAILED DESCRIPTION OF THE PREFERRED EMBODIMENT

With reference to FIG. 1, a liquid crystal display device 100 of the present invention includes a backlight module 1 and a display panel D, and the display panel D and the backlight module 1 are overlapped.

The backlight module 1 includes a back frame, a light source (not shown), a light guide plate (not shown) and multiple optical films (not shown). The back frame 10 is used for fixing the light source, a light guide plate and multiple optical films.

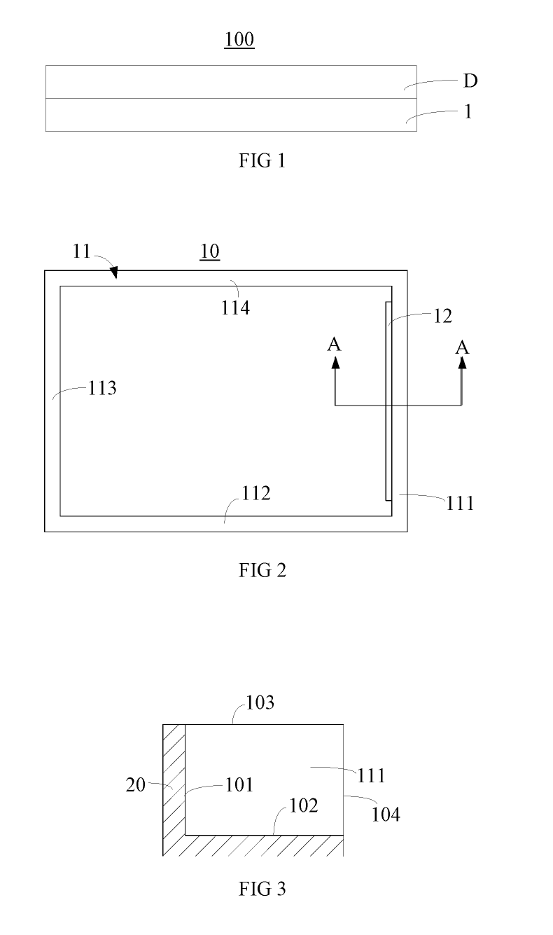

FIG. 2 is a schematic diagram of a back frame of a backlight module of the liquid crystal display device shown in FIG. 1 of a first embodiment. In the present embodiment, the back frame 10 includes a plastic frame 11 and a reinforcement member 12. The stiffness of the reinforcement member 12 is greater than the stiffness of the plastic frame 11. A heat dissipation performance of the reinforcement member 12 is better than a heat dissipation performance of the plastic frame 11. Preferably, the reinforcement member 12 is made of a metal material such as aluminum or stainless steel.

The plastic frame 11 includes four side walls connected in an end-to-end arrangement, sequentially as a first side wall 111, a second side wall 112, a third side wall 113 and a fourth side wall 114. Wherein, the first side wall 111 and the third side wall 113 are parallel with each other. The second side wall 112 and the fourth side wall 114 are parallel with each other. Two terminals of the first side wall 111 and the third side wall 113 are respectively perpendicularly connected with two terminals of the second side wall 112 and the fourth side wall 113. In the above side walls, each side wall includes four surfaces of an inner side surface 101, a bottom surface 102, a top surface 103 and an outer side surface 104. Wherein, the inner side surface 101 is a surface that is faced toward an opposite side wall, and the outer side surface 104 is a surface that is away from the opposite side wall. In a same side wall, the inner side surface 101 and the outer side surface 104 are disposed oppositely. The top surface 103 is a surface adjacent to the display panel D, the bottom surface 102 is a surface that is away from the display panel, and the top surface 103 and the bottom surface 102 are disposed oppositely.

The light source of a backlight module usually includes a direct-light type light source and a side-light type light source. The meaning of the direct-light type light source is that the light source is disposed right below the light guide plate. The meaning of the side-light type light source is that the light source is disposed at a side surface of the light guide plate. Using the backlight module adopting the side-light type light source as an example, the light source is disposed adjacent to a side wall of the back frame. In the present embodiment, the first side wall 111 is adjacent to the light source of the backlight module.

In the present embodiment, the reinforcement member 12 is only disposed at the first side wall 111. The reinforcement member 12 is extended along the first side wall 111 and is as “-” shape. Specifically refer to FIG. 2. with further reference to FIG. 3, the reinforcement member 12 is disposed at outside of the inner side surface 101 of the first side wall 111 and an outside of the bottom surface 102 connected with the inner side surface 101. In other words, the reinforcement member 12 surrounds the inner side surface 101 and the bottom surface 102 of the first side wall 111. Because the light source is disposed adjacent to the first side wall 111, the reinforcement member 12 is thermally contacted with the light source, besides, the reinforcement member 12 is not only disposed at the outside of the inner side surface 101 of the first side wall 111 but also disposed at the outside of the bottom surface 102 of the first side wall 111, the bottom surface 102 is disposed away from the display panel D, a portion of the reinforcement member 12 disposed at the outside of the bottom surface 102 is not only located at the exterior of the backlight module but also located at the exterior of the entire liquid crystal display device after assembled with the display panel D, accordingly, the reinforcement member 12 thermally contacted with the light source can conduct the heat of the light source to the exterior of the backlight module so as to effectively dissipate the heat of the light source.

The disposition of the reinforcement member 12 can obviously improve the heat dissipation effect of the backlight module. At the same time, because the stiffness of the reinforcement member 12 is greater than the stiffness of the plastic frame 11, the anti-disturbance stiffness of the backlight module can be obviously increased in order to effectively avoid the bending and deformation in the assembly process such that the backlight module has a higher assembly precision.

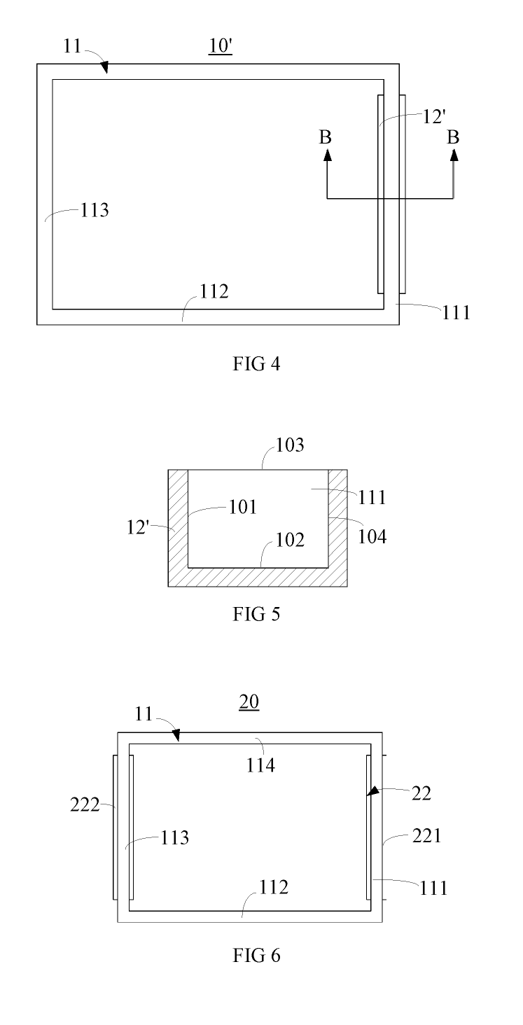

FIG. 4 and FIG. 5 show a back frame of a backlight module of the liquid crystal display device of a second embodiment. Comparing to the first embodiment, a reinforcement member 12′ of a back frame 10′ of the present embodiment is not only disposed at the outsides of the inner side surface 101 and the bottom surface 102 of the first side wall 111 but also disposed at an outside of the outer side surface 104 of the first side wall 111. In other words, the reinforcement member 12′ surrounds the inner side surface 101, the bottom surface 102 and the outer side surface 104 of the first side wall 111. Because the heat conduction path is further expanded, the heat dissipation effect of the present embodiment is also improved comparing to the previous embodiment.

FIG. 6 is a schematic diagram of a back frame of a backlight module of the liquid crystal display device of a third embodiment. Comparing with the back frame of the second embodiment shown in FIG. 4, the reinforcement member 22 of the back frame 20 includes two sub-reinforcement members 221 and 222. The sub-reinforcement member 221 is as “-” shape and surrounds the first side wall 111. The sub-reinforcement member 222 is as “-” shape and surrounds the third side wall 113. Comparing with the back frame shown in FIG. 5, disposing the sub-reinforcement members at the first side wall 111 and the third side wall 113 at the same time can further improve the stiffness of the back frame.

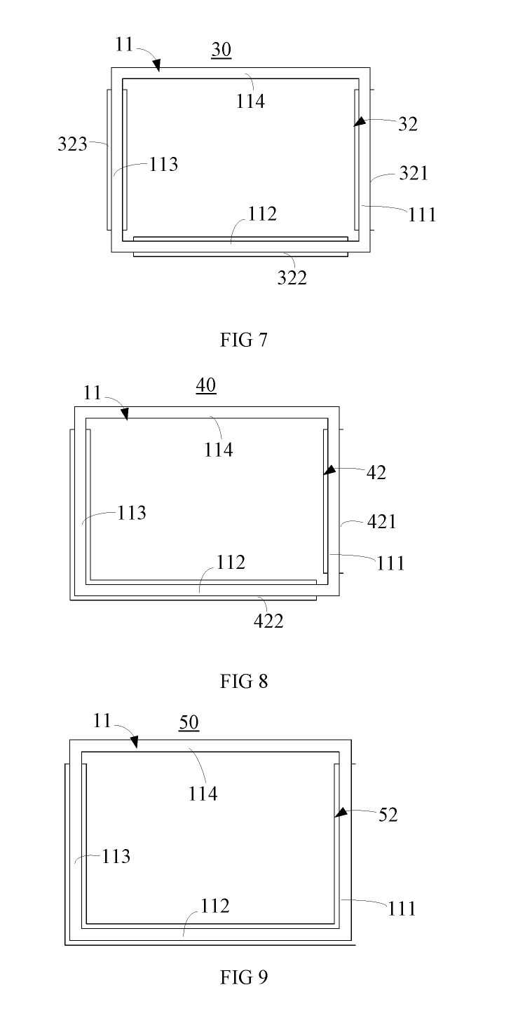

FIG. 7 is a schematic diagram of a back frame of a backlight module of the liquid crystal display device of a fourth embodiment. Comparing with the back frame of the third embodiment shown in FIG. 6, the reinforcement member 32 of the back frame 30 includes three sub-reinforcement members 321, 322 and 323. The sub-reinforcement member 321 is as “-” shape and surrounds the first side wall 111. The sub-reinforcement member 322 is as “-” shape and surrounds the second side wall 112. The sub-reinforcement member 323 is as “-” shape and surrounds the third side wall 113. Comparing with the back frame shown in FIG. 6, disposing the sub-reinforcement members at the first side wall 111, the second side wall 112 and the third side wall 113 at the same time can further improve the stiffness of the back frame.

As an alternative embodiment, the three sub-reinforcement members 321, 322 and 323 can also respectively surround the first side wall 111, the fourth side wall 114 and the third side wall 113.

FIG. 8 is a schematic diagram of a back frame of a backlight module of the liquid crystal display device of a fifth embodiment. Comparing with the back frame of the fourth embodiment shown in FIG. 7, the reinforcement member 42 of the back frame 40 of the present embodiment includes two sub-reinforcement members 421 and 422. The sub-reinforcement member 421 is as “-” shape and surrounds the first side wall 111. The sub-reinforcement member 422 is as “L” shape and surrounds outsides of the second side wall 112 and the third wall 113.

As an alternative embodiment, the “L” shaped sub-reinforcement member 422 can surrounds the outsides of the first side wall 111 and the second side wall 112 connected as “L” shape. The “-” shaped sub-reinforcement member surrounds the third side wall 113.

FIG. 9 is a schematic diagram of a back frame of a backlight module of the liquid crystal display device of a sixth embodiment. Comparing with the back frame of the fifth embodiment shown in FIG. 8, the reinforcement member 52 of the back frame 50 is as “[” shape, and is extended to surround the outsides of the first side wall 111, the second side wall 112 and the third side wall 113. In an actual application, the “[” shaped reinforcement member 52 can also surround the first side wall 111, the fourth side wall 114 and the third side wall 113.

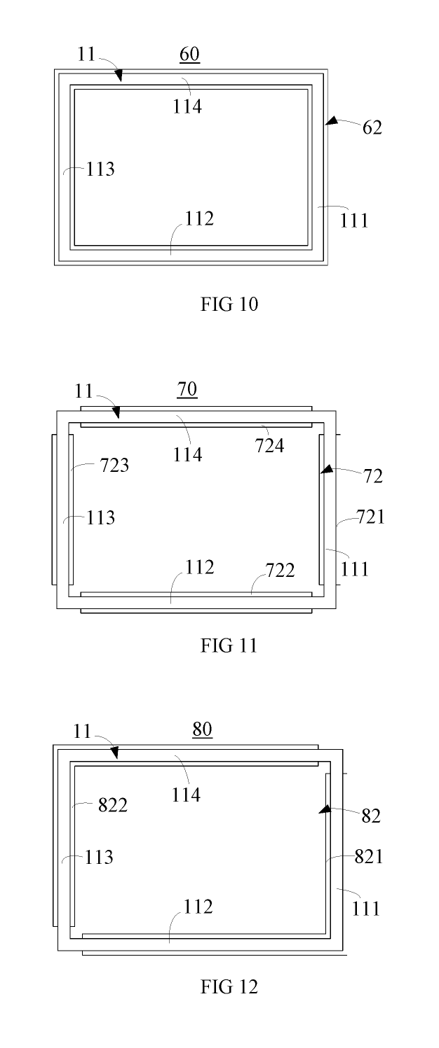

FIG. 10 is a schematic diagram of a back frame of a backlight module of the liquid crystal display device of a seventh embodiment. Comparing with the back frame of the sixth embodiment shown in FIG. 9, the reinforcement member 62 of the back frame 60 of the present embodiment is a “□” shape, and is extended to surround the outsides of the first side wall 111, the second side wall 112, the third side wall 113 and the fourth side wall 114. Comparing the reinforcement member disposed at one side wall, two side walls and three side walls, the reinforcement member disposed at four side walls has a strongest stiffness in the back frame in the embodiments.

FIG. 11 a schematic diagram of a back frame of a backlight module of the liquid crystal display device of an eighth embodiment. Comparing with the back frame of the seventh embodiment shown in FIG. 10, the reinforcement member 72 of the back frame includes four sub-reinforcement members 721, 722, 723 and 724. The sub-reinforcement member 721 is as “-” shape and surrounds the first side wall 111. The sub-reinforcement member 722 is as “-” shape and surrounds the second side wall 112. The sub-reinforcement member 723 is as “-” shape and surrounds the third side wall 113. The sub-reinforcement member 724 is as “-” shape and surrounds the fourth side wall 114.

FIG. 12 a schematic diagram of a back frame of a backlight module of the liquid crystal display device of a ninth embodiment. Comparing with the back frame of the eighth embodiment shown in FIG. 11, the reinforcement member 82 of the back frame 80 of the present embodiment includes two “L” shaped sub-reinforcement members 821 and 822. The sub-reinforcement member 821 surrounds the first side wall 111 and the second side wall 112. The sub-reinforcement member 822 is extended to surround the outsides of the third side wall 113 and the fourth side wall 114 connected as “L” shape.

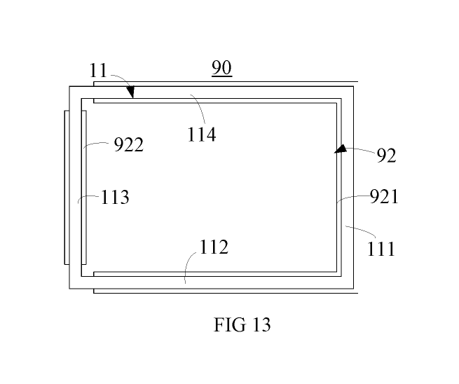

FIG. 13 a schematic diagram of a back frame of a backlight module of the liquid crystal display device of a tenth embodiment. Comparing with the back frame of the ninth embodiment shown in FIG. 12, the reinforcement member 92 of the back frame 90 of the present embodiment includes two sub-reinforcement members 921 and 922. Wherein, the sub-reinforcement member 921 is as “[” shape and is extended to surround the outsides of the fourth side wall 113, the first side wall 111 and the second side wall 112. The sub-reinforcement member 922 is as “-” shape and is extended to surround the outside of the third side wall 113. In an actual application, the “[” shaped sub-reinforcement member can also surround the first side wall 111, the second side wall 112 and the third side wall 113. The “-” shaped sub-reinforcement member can surround the outside of the fourth side wall 114.

In all embodiments described above, preferably, the reinforcement member and the plastic frame are formed integrally. In an actual application, the reinforcement member can also adopt an embedded method to fix the plastic frame relatively.

The beneficial effect of the present invention is: comparing to the conventional art, the back frame of the backlight module of the present invention includes a plastic frame and a reinforcement member. the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the backlight module has a better heat dissipation effect. At the same time, because the stiffness of the reinforcement member is greater than the stiffness of the plastic frame, the anti-disturbance stiffness of the back frame is increased so as to avoid generating bending and deformation when assembling, and the assembly precision is higher.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A backlight module for providing a backlight source to a display panel, comprising:
a back frame including a plastic frame and a reinforcement member;
wherein, a stiffness of the reinforcement member is greater than a stiffness of the plastic frame; the plastic frame includes four side walls connected in an end-to-end arrangement, sequentially as a first side wall, a second side wall, a third side wall and a fourth side wall; the first side wall is adjacent to a light source of a backlight module; the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the bottom surface is a surface that is away from the display panel.

2. The backlight module according to claim 1, wherein, the reinforcement member is further disposed at the third side wall.

3. The backlight module according to claim 2, wherein, the reinforcement member includes two “-” shaped sub-reinforcement members respectively extended along the first side wall and the third side wall.

4. The backlight module according to claim 2, wherein, the reinforcement member is further disposed at the second side wall and the fourth side wall.

5. The backlight module according to claim 4, wherein, the reinforcement member includes three “-” shaped sub-reinforcement members; or one “L” shaped and one “-” shaped sub-reinforcement members; or the reinforcement member is “[” shaped.

6. The backlight module according to claim 2, wherein, the reinforcement member is further disposed at the second side wall and the fourth side wall, and the reinforcement member includes four “-” shaped sub-reinforcement members; or the reinforcement includes two “L” shaped sub-reinforcement members; or the reinforcement member includes one “[” shaped sub-reinforcement member and one “-” shaped sub-reinforcement member; or the reinforcement member is “□” shaped matching with the plastic frame.

7. The backlight module according to claim 1, wherein, the reinforcement member is further disposed at an outer side surface of the first side wall, wherein, the outer side surface is opposite to the inner side surface.

8. The backlight module according to claim 1, wherein, the reinforcement member and the plastic frame are formed integrally.

9. The backlight module according to claim 1, wherein, the reinforcement member is a metal material.

10. A liquid crystal display device, wherein, the liquid crystal display device includes a backlight module and a display panel which are overlapped, and the backlight module comprises:
a back frame including a plastic frame and a reinforcement member;
wherein, a stiffness of the reinforcement member is greater than a stiffness of the plastic frame; the plastic frame includes four side walls connected in an end-to-end arrangement, sequentially as a first side wall, a second side wall, a third side wall and a fourth side wall; the first side wall is adjacent to a light source of a backlight module; the reinforcement member is disposed at outside of an inner side surface of the first side wall and an outside of a bottom surface of the first side wall connected with the inner side surface such that through the reinforcement member, a heat generated by the light source is conducted to an exterior of the backlight module, and the bottom surface is a surface that is away from the display panel.

11. The liquid crystal display device according to claim 10, wherein, the reinforcement member is further disposed at the third side wall.

12. The liquid crystal display device according to claim 11, wherein, the reinforcement member includes two “-” shaped sub-reinforcement members respectively extended along the first side wall and the third side wall.

13. The liquid crystal display device according to claim 11, wherein, the reinforcement member is further disposed at the second side wall and the fourth side wall.

14. The liquid crystal display device according to claim 13, wherein, the reinforcement member includes three “-” shaped sub-reinforcement members; or one “L” shaped and one “-” shaped sub-reinforcement members; or the reinforcement member is “[” shaped.

15. The liquid crystal display device according to claim 11, wherein, the reinforcement member is further disposed at the second side wall and the fourth side wall, and the reinforcement member includes four “-” shaped sub-reinforcement members; or the reinforcement includes two “L” shaped sub-reinforcement members; or the reinforcement member includes one “[” shaped sub-reinforcement member and one “-” shaped sub-reinforcement member; or the reinforcement member is “□” shaped matching with the plastic frame.

16. The liquid crystal display device according to claim 10, wherein, the reinforcement member is further disposed at an outer side surface of the first side wall, wherein, the outer side surface is opposite to the inner side surface.

17. The liquid crystal display device according to claim 10, wherein, the reinforcement member and the plastic frame are formed integrally.

18. The liquid crystal display device according to claim 10, wherein, the reinforcement member is a metal material.
